(19) United States
(12) Patent Application Publication
(10) Pub. No.: US 2006/0190997 A1
(43) Pub. Date: Aug. 24, 2006

(54) Method and system for transparent in-line protection of an electronic communications network

(76) Inventors: Amol Vijay Mahajani, Saratoga, CA (US); Tanuj Mohan, San Jose, CA (US); Joseph John Tardo, Palo Alto, CA (US); Dominic Martin Wilde, Morgan Hill, CA (US)

Correspondence Address: PATRICK REILLY, BOX 7218, SANTA CRUZ, CA, 95061-7218, US

(21) Appl. No.: 11/064,429

(22) Filed: Feb. 22, 2005

(51) Int. Cl. H04L 9/32

(52) U.S. Cl. 726/10

(57) ABSTRACT

The invention provides a method and system for enabling in-line communications channels between a plurality of computational systems and a switch, and/or a plurality of switches and a router. In a first version of the invention an in-line system receives uplinks of aggregated data from a plurality of switches and applies policies to the each aggregated data stream prior to transmission of the aggregated data streams from the in-line system to the router. At least one computational system provides a user identification associated with a user profile to the in-line system. The user profile informs indicates to the in-line system of the constraints imposed upon and activities permitted to the computational system originating the user identification. The constraints may include (a) one or more customized policies, (b) policies applicable to a group associated with the user identification, (c) virus/worm detection & protection, (d) a firewall, (e) virtual private network rules, and/or (f) encryption/decryption. In a second version the in-line system is configured to communicate directly with one or more computational systems as well as one or more switches.

### BACKGROUND OF THE INVENTION

1. Field of the Invention

The present invention relates to the field of electronic communications networks. More specifically, the present invention relates to applying policies by means of automated processes to the transmission and filtering of electronic messages to, from and within an electronic communications network

2. Description of the Prior Art

Electronic communications networks, such as the Internet, typically impose automated methods of managing communications between and among pluralities of electronic devices. Each electronic device may have one or more temporary or permanent network addresses, and certain devices may be accessed by more than one authorized user. Most electronic networks of any complexity include access levels and tiers. End systems may be bi-directionally communicatively coupled (“coupled”) with access tier devices, e.g. switches, through which access tiers devices users of the end systems may communicate with telecommunications routers, hubs, switches, other end systems, and other suitable electronic communications systems known in the art.

The prudent management of most electronic communications networks will include measures to detect and prevent attacks to the network from software viruses, to include software worms. The primary entry point of software viruses includes end systems themselves, as well as from electronic messages received from sources external to the subject network. The prior art includes efforts to limit user access to services on the bases of user authorizations and assigned access levels, yet is limited in effectiveness in applying authorization limitations at the point of unmediated communication between an end system and an access tier device. There is therefore a long felt need to apply user personalized communications authorizations, and limitations of authorizations, at communications nodes more proximate to an end system, as used by an end user, and in light of a user authorization profile.

### OBJECTS OF THE INVENTION

It is an object of the invention to provide a method to enable secure communications between electronic devices via a communications network

It is an optional object of the present invention to provide an in-line system that applies two or more policies to electronic message traffic originating from or addressed for delivery to an electronic device at least partly on the basis of a user profile.

It is another optional object of the present invention to provide an in-line system that receives an uplink from an electronic communications switch and applies policies to electronic message traffic received from the server at least partly on the bases of one or more user profiles.

It is yet another optional object of the present invention to provide an in-line system that provides electronic message traffic to a router at least partly on the basis of a plurality of policies and after the plurality of polices are applied to the electronic message traffic.

### SUMMARY OF THE INVENTION

Towards these and other objects that will be made obvious to one skilled in art and in view of the present disclosure, a first preferred embodiment of the method of the present invention (“first method”) provides a method to apply policies to electronic message traffic within an electronic communications network and to enhance the performance of the communications network. In the first method, polices are applied to electronic signals and/or messages (“communication traffic”) transmitted from an electronics communications device (e.g., a personal computer configured for bi-directional communication via the Internet, or an access tier layer 2 switch) and directed to the communications network by providing an in-line security system (“security system”), wherein the security system is interposed between the access tier layer 2 switch and the communications network. The first method enables the insertion of the security system within an existing computer network without requiring modifications to the pre-established assignment of network addresses or the pre-existing topology of the network. A plurality of security systems may, in certain yet alternate preferred embodiments of the first method, be comprised within an in-line system, wherein each security system is assigned to monitor and potentially modify a specific stream of aggregated communications traffic transmitted from an individual access tier layer 2 switch, or communications traffic form an end system, or electronic messages delivered from other suitable electronic communications device known in the art. The security system includes a communications security module, a first interface and a second interface, and both interfaces are coupled with the communications security module. The communications security module is configured and enabled to apply policies to the communication traffic and thereby generate a resultant traffic on the basis of one or more policies. The communications security module may optionally apply one or more polices in relationship to a user profile associated with an electronic message of the communications traffic. In an exemplary application of the operation of the first method, all or substantively all communications traffic transmitted by an access tier layer 2 switch, and addressed to a network address of the communications network, or intended for delivery to a destination via the communications network, is provided to the first interface. The communications security module then applies at least one security policy to this received communications traffic at least partly on the basis of at least one user profile associated with a user identification. The user profile directs the communications security module to apply one or more specified policies to communications traffic transmitted by and/or addressed to a network address associated with the user identification. The security module generates a resultant traffic by applying one or more polices to the communications traffic as received via the first interface and from the access tier layer 2 switch. The security module then transmits the resultant communications traffic to the communications network via the second interface. All traffic, or substantively all traffic, received by the computer network from the access tier layer 2 switch is thereby transmitted via the security system and in accordance with the at least one security policy.

In various alternate preferred embodiments of the method of the present invention incorporates one or more of the following features and capabilities:
> authentication of an individual user, enabling the security system to subsequently associate instances of network traffic with an individual user;
> selective association and application of a plurality of security policies in light of an individual user identity, using either a local database or an external authorization server;
> enforcement of a plurality of security policies based on user identity;
> enforcement of a policy imposing communication traffic filtering using a stateful firewall;
> communication traffic filtering based upon at least one traffic anomaly and protocol anomaly intrusion detection method;
> detection and blocking, i.e. inhibition of, a software worm or other software virus;
> quarantine of infected end systems by diverting all traffic to and from such an infected system to at least one remediation server;
> traffic filtering based on at least one signature intrusion detection method;
> traffic filtering based on at least one denial of service detection and mitigation method, whereby traffic policing, rate limiting, and/or bandwidth limiting methods may be applied;
> traffic filtering based on at least one in-line virus scanning method;
> traffic filtering based on at least one in-line content filtering method, whereby ActiveX, Java, Javascript, multimedia, and other suitable executable software code and software content known in the art may be filtered;
> a traffic logging and monitoring method;
> provision of a plurality of first interface and second interface pairs, each pair coupled with the communications security module, and the security system comprises a single device for securing a communications network including a plurality of access switches; and
> connection of a first security system and a second security system in a high availability configuration, whereby communications among a plurality of redundant aggregation tier switches is secured.

In a first preferred embodiment of the present invention (“first version”) a security system is communicatively coupled with a computer network The security system is configured for applying security policy to all communication traffic transmitted from an access tier layer 2 switch and directed to the computer network. The security system of the first version includes a first interface, a second interface and a communications security module, where the security module is bi-directionally communicatively coupled (“coupled”) with the first and second interface. The first interface receives all, or substantively all, communications traffic transmitted by the access tier layer 2 switch and intended for delivery to and/or via the computer network. The communications security module is configured to selectively apply at least one security policy to the communications traffic received by the first interface from the access tier layer 2 switch, and the second interface is enabled to transmit the communications traffic received by the first interface (from the access tier layer 2 switch) whereby all communications traffic received by the computer network from the access tier layer 2 switch is transmitted via the security system and in accordance with at least one security policy.

In various alternate preferred embodiments of the present invention the security system may comprise one or more of the following capabilities and features:
> a plurality of access interfaces for connecting individual end systems, and an uplink interface for connection into an aggregation tier, whereby the security system functions as an access switch;
> application of at least one method for authenticating individual users via an access interface;
> selective association of a plurality of interface security policies on the basis of individual user identity, using either a local database or an external authorization server;
> selective enforcement of security policies based on user identity on a per interface basis;
> traffic filtering using a stateful firewall or a distributed firewall;
> traffic filtering based on at least one traffic anomaly and protocol anomaly intrusion detection method;
> application of at least one worm detection and blocking, i.e. inhibition, method;
> quarantine of infected end systems by diverting all traffic to and from an infected system to a separate remediation system or sub-network;
> traffic filtering based on at least one signature intrusion detection method. > traffic filtering based on at least one denial of service detection and mitigation method, whereby traffic policing, rate limiting, and/or bandwidth limiting methods may be applied;
> traffic filtering based on at least one in-line virus scanning method;
> traffic filtering based on in-line content filtering, whereby ActiveX,Java, Javascript, multimedia, and other suitable executable content known in the art may be filtered;
> one traffic logging and monitoring; and
> an interface type that enables the access switch to enforce at least one of the plurality of security policies for multiple users.

### BRIEF DESCRIPTION OF THE DRAWINGS

These, and further features of the invention, may be better understood with reference to the accompanying specification and drawings depicting the preferred embodiment, in which:

FIG. 1 presents a prior art subnetwork Intranet coupled with the Internet.

FIG. 2 illustrates a computer network enabled to implement the first preferred embodiment of the method of the present invention and including an in-line system.

FIG. 3 is a schematic diagram of a security system of an in-line system of FIG. 2.

FIG. 4 is a flowchart of a portion of the first method that may be implemented by means of the computer network of FIG. 2.

FIG. 5 is a flowchart of a second portion of the first method that may be implemented by means of the computer network of FIG. 2.

FIG. 6 is a policy database compliant with the first method of Figures

FIG. 7 is a profile database that is compliant with the first method of Figures

FIG. 8 depicts an alternate computer network enabled to implement an alternate preferred embodiment of the method of the present invention.

### DETAILED DESCRIPTION OF THE PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the present invention have been defined herein.

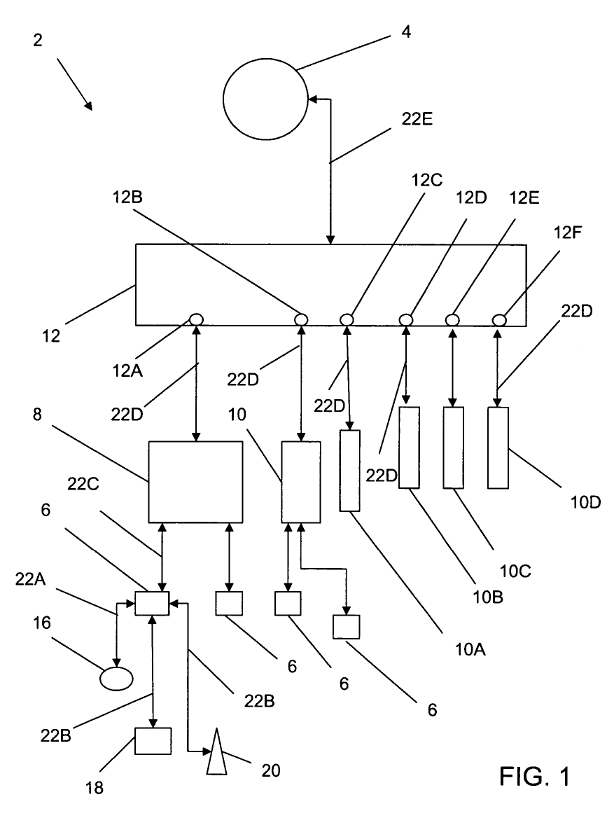

Referring now generally to the Figures and particularly to FIG. 1, a prior art subnetwork 2 is coupled with the Internet 4. A plurality of end systems 6 are coupled with a first switch 8, a second switch 10, or one of a plurality of switches 10A-D. The first switch 8 and the second switch 10 are coupler with a router 12. Each end system 6 is an electronic computational device configured to provide bi-directional communications with the Internet and/or other suitable electronics communications network 14 known in the art. System 14 is an end system that is configured and designated as a remediation server and receives electronic messages diverted from a network address destination. Each end system 6 has an output device 16 and one or more input devices 18 & 20. The output device may be a video screen or other suitable data presentation, storage or communication device known in the art. A first input device 18 is a keyboard and a second input device 20 is a biometric reader, such as a thumb pattern reader or a human eye pattern reader.

A plurality of network cables 22A-22E are configured to enable bi-directional electronic message and signal communications within the end systems (22A & 22B), between the end systems 6 and the switches 8 & 10 (cables 22C), between the switches 8, 10 & 10A-D and the router 12 (cables 22D), and between the router 12 and the Internet 4 (cables 22E). The switches 8, 10 & 10A-D are access tier layer 2 switches, and the router 12 are configured to provide bi-directional electronic message communication among the plurality of end stations 6, and between the switches 8, 10 and 10A-D and the Internet 4. The subnetwork 2 comprises the plurality of end systems 6, the switches 8, 10 & 10A-D, the router 12 and a plurality of network cables 22A-E. The router 12 includes a plurality of router ports 12A-F, where each router port 12A-F coupled with one of a plurality of switches 8, 10 & 10A-D by means of one of the plurality of cables 22D. More particularly, the cables 22D establish a communications uplink from the first switch 8, the second switch 10, and the additional switches 10A-D

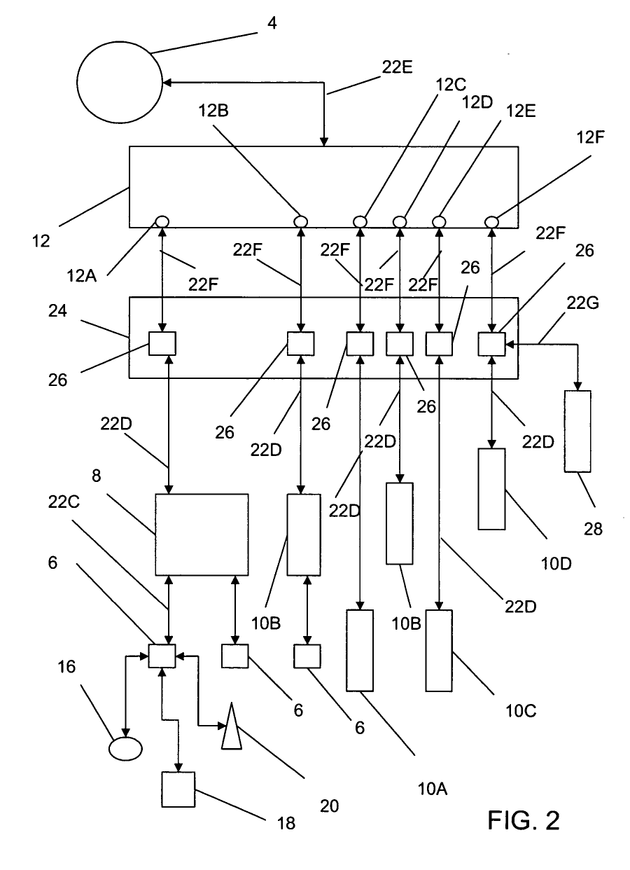

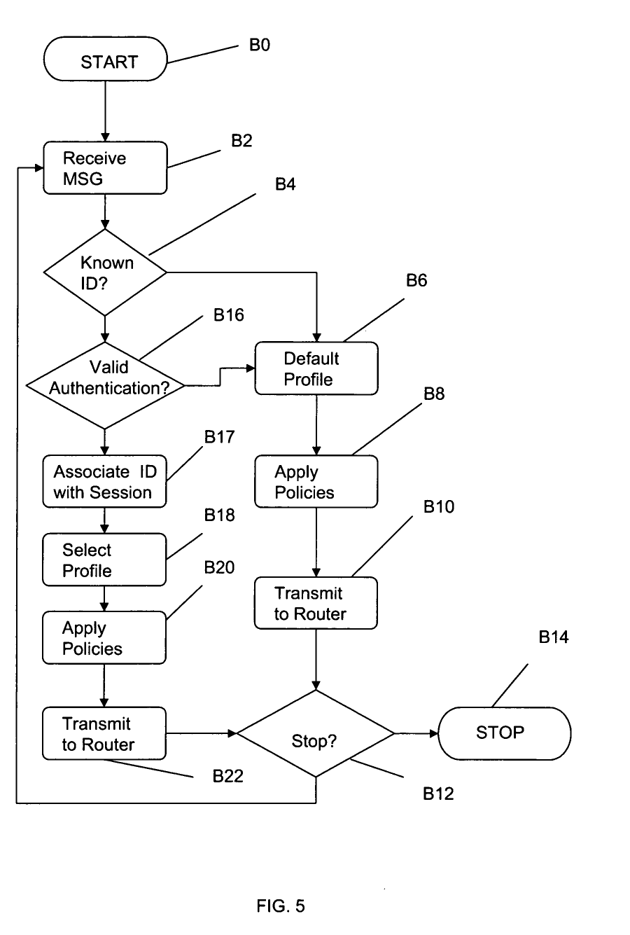

Referring now generally to the Figures and particularly to FIG. 2, FIG. 2 illustrates a computer network 22 enabled to implement the first preferred embodiment of the method of the present invention. Computer network 22 is compliant with Internet communications protocols and is optionally coupled with the Internet. An in-line system 24 having a plurality of security systems 26 is interposed between the router 12 and the switches 8 & 10. Separate cables 22D enable bi-directional electronic communications between each security system 26 and one specific switch 16 or 18. A plurality of cables 22F each separately enable bi-directional electronic communications between one security system 26 and one port 12A-12F of the router 12. The in-line system 24 is interposed between the router 12 and the switches 8, 10 & 10A-D by means of the cables 22D & 22F and the security systems 26. Each of the cables 22F deliver communications traffic to a specific router port 12A-F in a stream of resultant traffic, wherein each individual stream of resultant traffic is formed by the processing by a single security system 26 of a communications traffic stream originated solely by one individual switch 8, 10, & 10 A-10D. In certain other alternate embodiments of the method of the present invention one or more of the cables 22F deliver communications traffic to a specific router port 12A-F in a stream of resultant traffic, wherein each individual stream of resultant traffic is formed by the processing by a single security system 26 of a communications traffic stream originated solely by an end system 6, and/or other suitable communications device known in the art, and as illustrated in FIG. 5. Each security system 26 receives aggregated communications traffic from a switch 8, 10 & 10A-D, applies security policies (“policies”) to the received aggregated traffic to generate a resultant traffic, and then transmits the resultant traffic to the router 12 via one of the cables 22F. Each security system 26 is dedicated to processing the communications traffic of one and only one switch 8, 10 & 10A-D en route from the originating switch and prior to receipt by one of the router ports 12A-12F. The insertion of the in-line system into the computer network 22 is substantively transparent to the router 12, and is effected without requiring an alteration of the topology of the computer network 22 as established prior to and without consideration of the later inclusion of the in-line system 24 within the computer network 22. Two or more security systems 26 are connected in a high availability configuration, whereby communication among a plurality of redundant aggregation tier switches 8, 10, & 10A-D are secured.

A security system server 28 is coupled, i.e. bi-directionally communicatively coupled, with each security system 26 by means of a plurality of cables 22G. The plurality of cables 22G are each configured to enable bi-directional communication between at least one security system 26 and the security system server 28. The security system server 28 may be used to program and refresh the security systems 26 by providing new user information and policy definitions for general or selective application to communications traffic by the security systems 26. Alternatively or additional, the security systems 26 may be reprogrammed or receive updated software coded instructions or data from the router 12, one or more end systems 6, and one or more switches 8, 10 & 10A-D.

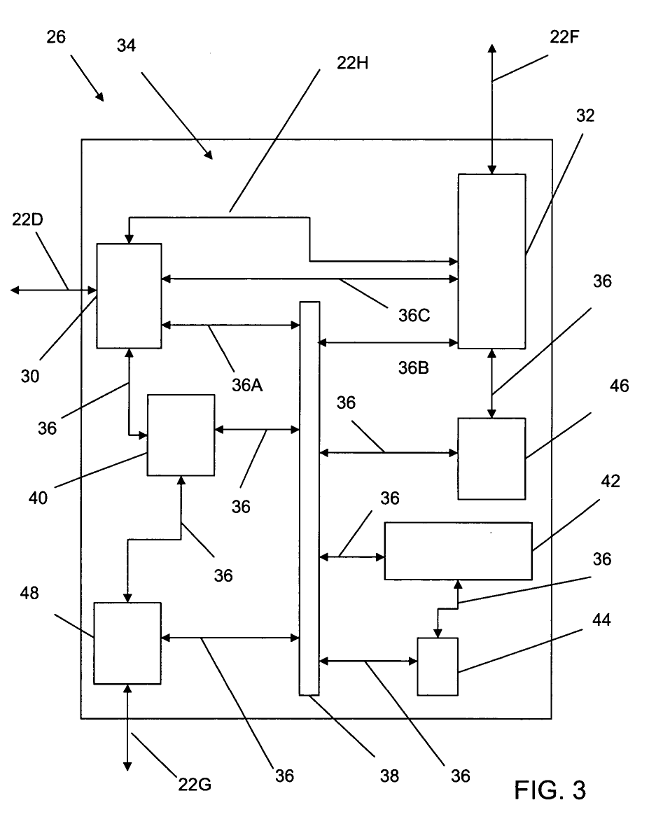

Referring now generally to the Figures and particularly to FIG. 3, FIG. 3 is a schematic diagram of a security system 26 of the in-line system 24 of FIG. 2. The security system 26 includes a first interface 30, a second interface 32 and a communications security module 34. The communications serial module 34 includes the security system less the first interface 30 and the second interface 32. A plurality of signal pathways 36 and a communications bus 38 enable bi-directional communications between, within and among the first interface 30, the second interface 32 and the communications security module 34. The first interface 30 is coupled with the first switch 8 by the cable 22D and with the communications bus 38 by a subset 36A of the signal pathways 36. The second interface 32 is coupled with a router port 12A of the router 12 by the cable 22F and with the communications bus 38 by a subset 36B of the signal pathways 36. An optional subset 36C of the signal pathways 36 provide an alternate pathway for communications traffic between the first interface 30 and the second interface 32. The first and second interfaces 30 & 32 may be programmed or designed, in certain still alternate preferred embodiments of the method of the present invention, to enable transmission of selected electronic messages via the optional subset 36C and without examination, processing and/or modification by the communications security module 34. The optional subset 36C may optionally be or comprise a network cable 22H.

A first buffer memory 40 receives communications traffic from the first interface 30 and provides access to the communications traffic to a central processing unit (“CPU”) 42, an operational memory 44, and/or a second buffer memory 46 via the communications bus 38. The CPU 42 is configured to process, analyze, modify and report on communications traffic received from the first interface 30 and in accordance with user profile information and policies as stored in are made available by the operational memory 44. The operational memory 44 additionally may store and enable the implementation of at least a part of a security system software program, where the security system software comprises software code that directs the CPU 42 to execute the first method. The second buffer memory 46 receives resultant traffic from the CPU 42, an operational memory 44, and/or the first buffer 30 via the communications bus 38. The resultant traffic is transmitted from the second buffer 46. A third interface 48 is coupled with the security system server 28 and the communications bus 38, whereby the security system server 28 may provide new information, or update or modify previously stored information or software code, concerning or comprised within the security system software, one or user profiles, and/or one or more policies.

It is understood that each network cable 22A-22H is selected, matched and configured to enable bi-directional electronic message and signal communications between any two suitable electronic devices 6, 8, 10, 10A-D, 12, 14, 16, 18, 20, 24, & 26 to which the cable 22A-22H is deployed to couple.

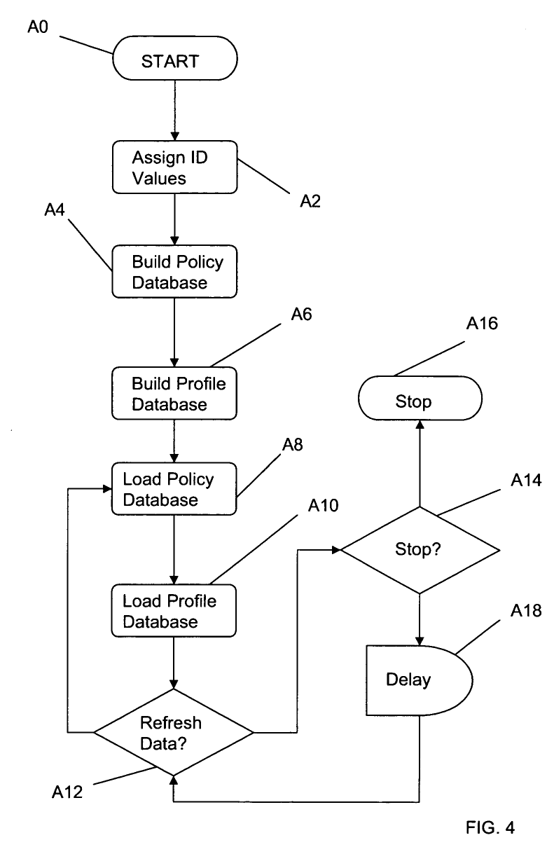

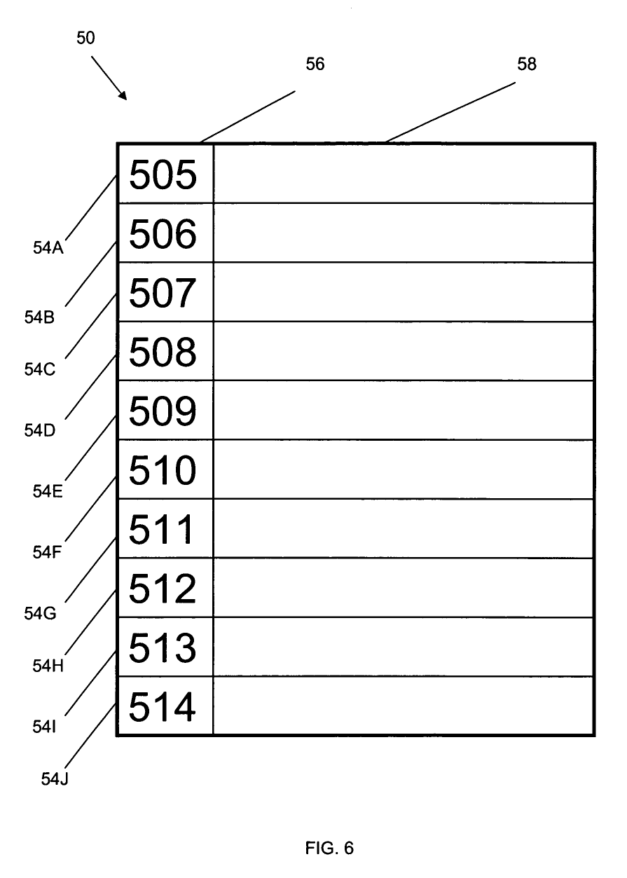

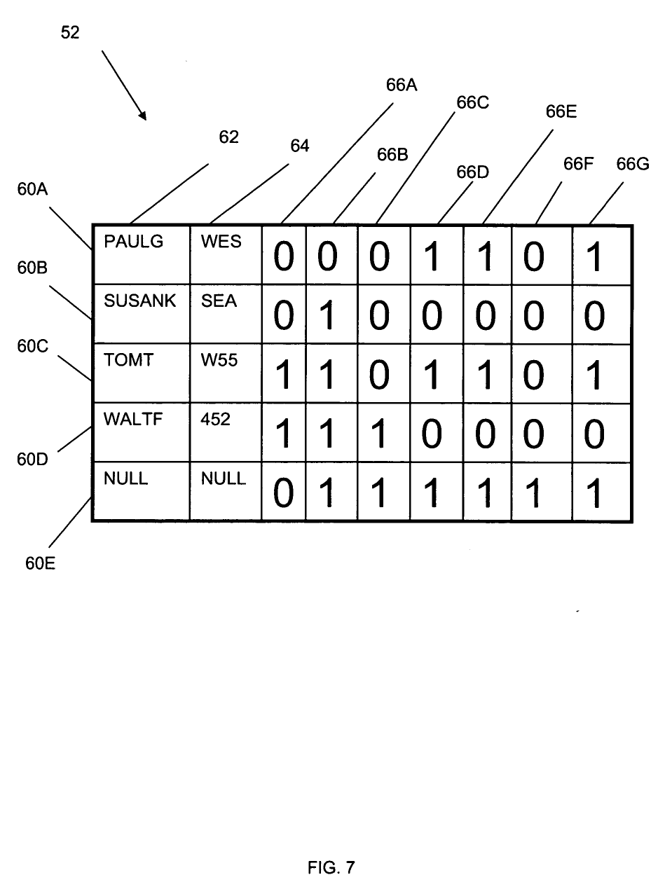

Referring now generally to the Figures and particularly to FIGS. 4 and 5, FIGS. 4 and 5 are flowcharts of elements of the execution system software that may be implement the first method by means of the computer network 22 of FIG. 2. Implementation of the first method by the system software includes the design, instantiation and loading with software coded instructions and data of a policy database 50 (as per FIG. 6) and an identification database 52 (“ID data base 52”, and as per FIG. 7). In various yet other alternate preferred embodiments of the method of the present invention the system software and the databases 50 & 52 may be authored by means of and stored in a distributed manner among one or more in-line systems 24, security systems 26, and other suitable electronic computational and data memory devices known in the art and coupled with one or more security systems 26. The plurality of security systems 26 execute the examination and modification of data streams originating from end systems 6 and switches 8, 10, & 10A-B and it is understood that the functionality of two or more security systems 26 may be at least partially provided by a unitary electronic circuit, module and/or semiconductor device comprised within the on-line system 24. The software instructions driving the aspects of version one as presented in the flow charts of FIGS. 4 and 5 may be at least partially stored in and executed by the security system server 28 and/or one or more of the security systems 26.

Referring now generally to the Figures and particularly to FIG. 4, FIG. 4 present the steps A0-A8 of building databases 50 & 52 and populating the databases 50 & 52 with data useful for filtering and modifying communications traffic by a security system 26. In step A2 identification values (“ID's”) are assigned to human beings and optionally other entities. In step A4 the policy database 50 is constructed having (as per FIG. 6) a plurality of policy records 54A-J, each policy record 54A-J including a reference number data field 56 and a policy instruction data field 58. In step A6 the profile data base 52 is constructed to include a plurality of profile records 60A-E, each profile record 60A-E having an ID data field 62, an authentication data field 64, and a series of policy enablement data fields 66A-G. The policy database 50 and the profile database 52 are further described below. In step A8 the policy records 54A-J of the policy data base 50 is loaded with policy reference numbers into the reference number data fields 56 and executable software coded instructions are entered into corresponding policy instruction data fields 58. Any particular policy record the 54A stores a unique policy reference number and an executable software comprising coded instruction(s) to enable a security system 26 to implement the policy associated with the policy reference number. In step A10 data is entered into the plurality of profile records 60A-E, wherein ID's are written into the ID data fields 62, authentication data associated with each ID is written into a corresponding authentication data field 64, and a series of policy enablement indicators associated with the corresponding ID stored in the ID data filed of the profile record 60A-E are written into the corresponding data fields 66A-G. Each profile record 60A-E is then enabled to inform a security system 26 of existing ID assignments, authentication data associated with each ID, and the specific policies of the policy data base 50 that are to be implemented upon receipt by the security system 26 of communications traffic associated with each known ID. A default profile record 60E may be used by a security system 26 to selectively implement policies against communications traffic that is not associated with any known ID, or an unauthenticated ID. Step A12 is executed after step A10, wherein the system software determines if the databases 50 & 52 shall be refreshed with new data. If new policy records 50, new profile records 52, and/or data in existing records are to be modified to be entered into either database 50 & 52, the system software proceeds to step A8 to load the policy database 50 with new policy records 54A-J and/or modify data in existing policy records 54A-J. The system software then executes step A10 by modifying existing profile records 60A-E and/or adding new profile records to the profile record database 52. In the alternative choice available in step A12, the system software may proceed from step A12 to step A14 wherein the system software determines if the building and populating the databases 50 & 52 shall be halted by proceeding on to step A16, or onto a wait step A18. During the wait step A18 the steps of system software steps of B0-B22 of FIG. 5 may be executed. From wait step A18 the system software proceeds on to step A12 to determine if either database 50 & 52 shall be refreshed with new data and/or new records 54A-J or 60A-60E.

Referring now generally to the Figures and particularly to FIG. 5, FIG. 5 is a flowchart of aspects of the first method that may be implemented by means of the computer network of FIG. 2. Steps A0 through A16 may be executed in step B0. In step B2 an electronic message or signal (“message”) is received by a security system 26. In step B4 the security system examines a header of the message to determine if a pre-established ID as recorded in the ID profile database 52 is associated with the message as a sender of the message. If the sender of the message is not associated with in ID in step B4, the default profile record 60E and the policies selected for implementation by the profile record as applied in step B8. The message as modified, if at all, by the application of selected policies in step B8 is then transmitted to the router 12 in step B10. The first method next determines in step B12 if the processing of another message shall begin, or if the security system 26 shall at least temporarily halt communications traffic processing. If the system software determines that communications traffic is to be halted, step B14 is the executed and the first method is paused until the system software reinitiates step B2 to begin processing another message. Alternatively, the system software may proceed directly from step B12 to step B2. Where an ID of the message sender is found (in step B4) that is both associated with the sender of the message and is recorded in an ID data field 62 of a profile record 60A-E of the profile data base 52, the system software proceeds onto an optional step B16 to search the message (or read a header of the message) for an authentication data identical to an authentication data recorded in the authentication data field 64 of the relevant profile record 60A-E. The authentication data may be at least partially derived from a password, an encryption key, and/or biometric data, e.g. a digitally represented fingerprint pattern or eye retina image. The biometric data may be produced by human operation of the biometric reader 20 and transmission of biometric data generated by the biometric reader to the security system 26. If authentication data cannot be found in the message or cannot be validated by comparison with validation data stored in the relevant profile record 60A-60E, then the system software proceeds from step B16 and onto step B6 to apply the default profile 60E as discussed above. Where validation data is found and validated against the relevant authentication data recorded in the authentication field 64 of the relevant data profile 60A-E, the system software next executes step B17 where the session comprising the message is associated with the matching and authenticated ID. Step B17 ensures that all messages of the session (of the message being processed) later received by the security system 26 will be processed according to the related profile record. The system software then executes step B18, wherein the profile record 60A-E is selected that has both the ID of the message sender stored in the ID data field 62 and the authentication data of the message stored in the authentication data field 64. In step B22 the policies selected for application by the profile record selected in steps B4 and B16 are applied to the message, to produce a resultant traffic message. The resultant traffic message is then transmitted to the router in step B22. The first method next determines in step B12 if the processing of another message shall begin, or if the security system 26 shall at least temporarily halt communications traffic processing. If the system software determines that communications traffic is to be halted, step B14 is then executed and the first method is paused until the system software reinitiates step B2. Alternatively, the system software may proceed directly from step B12 to step B2.

Referring now generally to the Figures and particularly to FIG. 6, FIG. 6 is a policy database 50 compliant with the first method of FIGS. 2-5 and FIG. 7. The policies that may be implemented by means of the system software and the executable software coded instructions (as stored in one or more policy records 54A-J) may implement one or more of the following processes, features and communications traffic management steps:
> authentication of an individual user, enabling the security system to subsequently associate instances of network traffic with an individual user;
> selective association and application of a plurality of security policies in light of an individual user identity, using either a local database or an external authorization server;
> enforcement of a plurality of security policies based on user identity;
> enforcement of a policy imposing communication traffic filtering using a stateful firewall;
> communication traffic filtering based upon at least one traffic anomaly and protocol anomaly intrusion detection method;
> detection and blocking, i.e. inhibition of the propagation or function of, a software worm or other software virus;
> quarantine of an infected end system(s) by diverting all traffic to and from an infected system to at least one remediation server;
> traffic filtering based on at least one signature intrusion detection method;
> traffic filtering based on at least one denial of service detection and mitigation method, wherein traffic policing, rate limiting, and/or bandwidth limiting methods may be applied;
> traffic filtering based on at least one in-line virus scanning method;
> traffic filtering based on at least one in-line content filtering method, whereby ActiveX, Java, Javascript, multimedia, and other suitable executable content known in the art may be filtered; and
> a traffic logging and monitoring method.

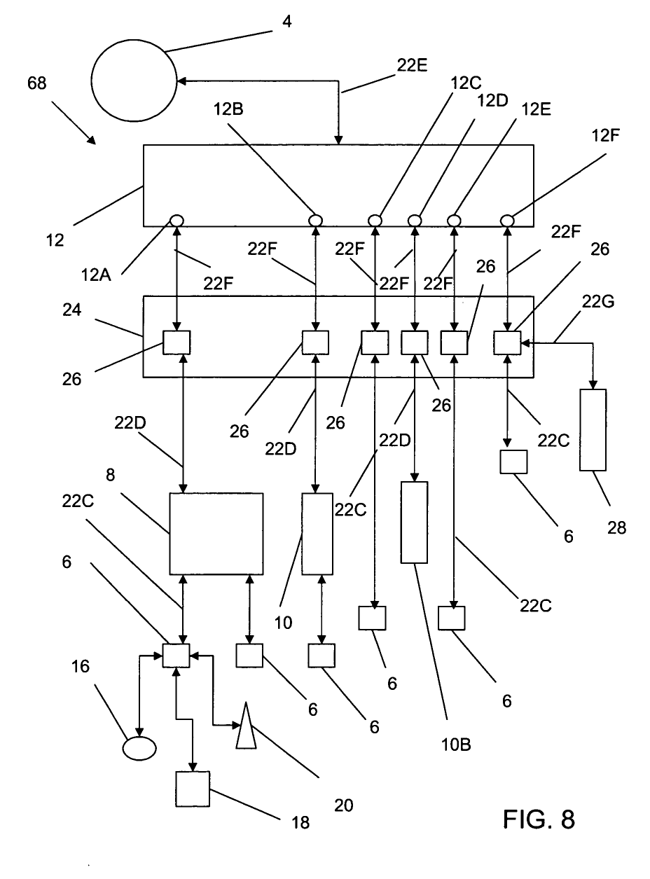

Referring now generally to the Figures and particularly to FIG. 8, FIG. 8 depicts an alternate computer network 68 enabled to implement an alternate preferred embodiment of the method of the present invention. A plurality end systems 6 are each directly coupled with one of the plurality of security systems 26 of the in-line system 24, whereby the in-line system functions as an access tier layer 2 switch for the end systems 6. The in-line system 24 simultaneously filters traffic between the plurality of end systems 6, the first switch 8, the second switch 10, and the additional switch 10B.

It is understood that the system software comprises instruction recorded in executable code that may, in various additional alternate preferred embodiments of the method of the present invention, be implemented by the in-line system 24, one or more of the security systems 26, and/or the security system server 28. It is also understood that the security server 28 may act as an external authorization server to enable or prohibit the transmission of messages by the security systems 26 and in accordance with one or more policies of the policy database 50.

One or more end systems 6 may be used as remediation systems, wherein communications traffic may be redirected by the in-line system 24 for processing and/or storage in the remediation system and without delivery to the message's destination network address.

Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

We claim:

1. In a computer network, a method for applying security policy to communication traffic transmitted from an access tier layer 2 switch and directed to the computer network, the method comprising:
a. providing a security system, the security system comprising a first interface, a second interface and a communications security module, the first interface coupled with the communications security module and the communications security module coupled with the second interface;
b. interposing the security system between the access tier layer 2 switch and the computer network, wherein all communications traffic transmitted by the access tier layer 2 switch for is provided to the first interface;
c. configuring the communications security module to apply at least one security policy to the communications traffic received by the first interface from the access tier layer 2 switch; and
d. applying the at least one security policy to the communications traffic received by the first interface from the access tier layer 2 switch by means of the communications security module; and
e. transmitting the communications traffic transmitted from the access tier layer 2 switch to the security system to the computer network via the second interface and in accordance with the at least one security policy, whereby all traffic received by the computer network from the access tier layer 2 switch is transmitted via the security system and in accordance with the at least one security policy.

2. The method of claim 1, wherein the security system incorporates one or more method for authenticating individual users, enabling the security system to subsequently associate instances of network traffic with individual users.

3. The method of claim 2, wherein the security system selectively associates and applies a plurality of security policies in light of an individual user identity, using either a local database or an external authorization server.

4. The method of claim 3, wherein the security system selectively enforces the plurality of security policies based on user identity.

5. The method of claim 4, wherein the plurality of security policies include communication traffic filtering using a stateful firewall

6. The method of claim 4, wherein the plurality of security policies include communication traffic filtering based upon at least one traffic anomaly and protocol anomaly intrusion detection method.

7. The method of claim 4, wherein the plurality of security policies include at least one application of a worm detection and blocking method.

8. The method of claim 7, wherein the plurality of security policies include a quarantine of infected end systems by diverting all traffic to and from such an infected system to at least one remediation server.

9. The method of claim 4, wherein the plurality of security policies include traffic filtering based on at least one signature intrusion detection method.

10. The method of claim 4, wherein the plurality of security policies include traffic filtering based on at least one denial of service detection and mitigation method, whereby traffic policing, rate limiting, and/or bandwidth limiting methods may be applied.

11. The method of claim 4, wherein the plurality of security policies include traffic filtering based on at least one in-line virus scanning method.

12. The method of claim 4, wherein the plurality of security policies include traffic filtering based on at least one in-line content filtering method, whereby ActiveX, Java, Javascript, multimedia, and other suitable executable content known in the art may be filtered.

13. The method of claim 4, wherein the plurality of security policies include at least one traffic logging and monitoring method.

14. The method of claim 1, wherein the system presents a plurality of first interface and second interface pairs, each pair coupled with the communications security module, and the security system comprises a single device for securing a communications network including a plurality of access switches.

15. The method of claim 14, wherein the security system and a second security system are connected in a high availability configuration, whereby communications among a plurality of redundant aggregation tier switches is secured.

16. In a computer network, a security system configured for applying security policy to all communication traffic transmitted from an access tier layer 2 switch and directed to the computer network, the security system comprising:
a. a first interface, a second interface and a communications security module, the first interface coupled with the communications security module and the communications security module coupled with the second interface;
b. the first interface for receiving all communications traffic transmitted by the access tier layer 2 switch and directed to the computer network;
c. communications security module configured to apply at least one security policy to the communications traffic received by the first interface from the access tier layer 2 switch; and
d. the second interface for transmitting communications traffic received by the first interface and from the access tier layer 2 switch, and via the communications security module in accordance with the at least one security policy, whereby all traffic received by the computer network from the access tier layer 2 switch is transmitted via the security system and in accordance with the at least one security policy.

17. The security system of claim 16, wherein the security system further comprises a plurality of access interfaces for connecting individual end systems, and an uplink interface for connection into an aggregation tier, whereby the security system functions as an access switch.

18. The security system of claim 17, wherein the security system applies at least one method for authenticating individual users on an access interface.

19. The security system of claim 17, wherein the security system selectively associates a plurality of interface security policies on the basis of individual user identity, using either a local database or an external authorization server.

20. The security system of claim 19, wherein the security system selectively enforces security policies based on user identity on a per interface basis.

21. The security system of claim 19, wherein at least one interface security policy includes traffic filtering using a stateful firewall or a distributed firewall.

22. The security system of claim 19, wherein at least interface security policy applied by the security system includes traffic filtering based on at least one traffic anomaly and protocol anomaly intrusion detection method.

23. The security system of claim 19, wherein at least interface security policy includes application of at least one worm detection and blocking method.

24. The security system of claim 19, wherein at least one interface security policy includes quarantine of infected end systems by diverting all traffic to and from such an infected system to at least one remediation server.

25. The security system of claim 19, wherein at least one interface security policy includes traffic filtering based on at least one signature intrusion detection method.

26. The security system of claim 19, wherein at least one interface security policy includes traffic filtering based on at least one denial of service detection and mitigation method, whereby traffic policing, rate limiting, and/or bandwidth limiting methods may be applied.

27. The security system of claim 19, at least one interface security policy includes traffic filtering based on at least one in-line virus scanning method.

28. The security system of claim 19, wherein the plurality of interface security policies includes traffic filtering based on in-line content filtering, whereby ActiveX, Java, Javascript, multimedia, and other suitable executable content known in the art may be filtered.

29. The security system of claim 19, wherein the plurality of interface security policies include at least one traffic logging and monitoring method.

30. The security system of claim 19, wherein the access switch includes an interface type that enables the access switch to enforce at least one of the plurality of security policies for multiple users.
